(19) United States
(12) Patent Application Publication
(10) Pub. No.: US 2025/0378435 A1
(43) Pub. Date: Dec. 11, 2025

(54) IDENTIFICATION-BASED PAYMENT

(71) Applicant: Wells Fargo Bank, N.A., San Francisco, CA (US)

(72) Inventor: Matthew Edward Carroll, Charlotte, NC (US)

(21) Appl. No.: 18/738,413

(22) Filed: Jun. 10, 2024

(51) Int. Cl. G06Q 20/36; G06Q 20/34

(52) U.S. Cl. CPC G06Q 20/363; G06Q 20/341

(57) ABSTRACT

Initiating payments using identity verification. A personal identifier that uniquely identifies a prospective payor can also initiate a requested payment without the need for a payment mechanism other than the personal identifier itself. Whether payment is initiated by the personal identifier can depend on a context in which the payment request is made.

### BACKGROUND

Certain transactions are associated with a requirement that an identification of the payor is verified. A payor provides a form of identification and a form of payment to execute the transaction.

### SUMMARY

In general terms, the present disclosure relates to an identification-based payment in which verification of a payor's identity initiates a payment.

In one aspect, the present disclosure relates to an augmented passport, the augmented passport including: a substrate; information printed on or otherwise encoded on the substrate sufficient to enable the payor to lawfully enter a plurality of countries; and a payment device printed on or embedded within the substrate, the payment device being configured to be scanned by an electronic scanning device to initiate a payment from an account associated with the payor.

In a further aspect, the present disclosure relates to a payment system, including: an electronic scanning device; at least one processor; and memory encoding instructions which, when executed by the at least one processor, cause the at least one processor to verify an identification of a payor based on a scan, by the electronic scanning device, of the unique identifier to provide a verified identification, wherein the verified identification causes a payment to be initiated from an account associated with the payor.

In yet a further aspect, the present disclosure relates to a method of executing a payment, the method including: receiving, by a server, a verification of a unique identifier of a payor and a request to initiate the payment; generating, by the server, a key based on the verification; and electronically initiating the payment by providing the key to a clearinghouse, the key being configured to enable the clearinghouse to withdraw the payment from an account of the payor.

Each of these aspects, and other aspects, of the present disclosure, can be implemented in a variety of ways including, for example, in the form of one or more of a computing system, a computing device, a method (e.g., a computer-implemented method), non-transitory computer-readable storage, a plurality of computing devices, and the like.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example identification-based payment management system.

FIG. 2 shows example augmented passport used in conjunction with the identification-based payment management system of FIG. 1.

FIG. 3 shows an example method that can be performed by the system of FIG. 1.

FIG. 4 shows example physical components of portions of the system of FIG. 1.

### DETAILED DESCRIPTION

Customers of financial institutions hold transaction accounts, such as checking accounts, savings accounts, and credit card accounts, that are managed by the financial institutions. Online transaction services provided by the financial institutions can enable customers to make payments from their transaction accounts to payee transaction accounts of their choice.

As the term is used herein, a payor is a person.

As the term is used herein, a payee can be any of: a person, a business, a merchant, a financial institution, a government entity, and the like.

As the term is used herein, a unique identifier of a payor is an identifier that can verify the payor's identity when the payor is physically present and presenting the unique identifier. One example of a unique identifier is a government-issued passport. Another example of a unique identifier is a government-issued driver's license. Another example of a unique identifier is a biomarker (e.g., a retina configuration, a fingerprint) that can be detected from the payor when the payor is physically present.

In a typical online payment transaction, a financial institution server receives an online request from a payment mechanism to make a payment from a payor's transaction account to a payee account. The payment mechanism can be, for example, a transaction card (e.g., a debit card or a credit card) that is swiped at a transaction card reader, a smart device that is positioned near a payment terminal, or a payment software or web application through which the payor has logged into access their financial account and make transactions.

Certain transactions require that the payor's identification be verified. For example, when crossing a border into another country, a payment for a travel visa may be required and must be accompanied by verification of the payor requesting the visa. Such a verification is typically made by inspection of a government-issued passport presented by the payor. However, in these circumstances, a payment mechanism separate from the passport is still needed to make the payment.

In certain situations, such as in a foreign country, an attempted payment may be blocked by the financial institution managing the transaction account linked to the payment mechanism used as a precaution against fraud. Blocking of such a payment may be particularly harmful to the payor if it is needed to, e.g., return to their country of nationality or to enter one country from another country. That is, in such situations, the payor's financial institution's fraud prevention policies and procedures may be over-inclusive by blocking non-fraudulent transactions, thereby harming or at least inconveniencing the payor attempting to execute a legitimate transaction.

In other situations, a financial institution might initiate a requested transaction without an identification of the payor being verified. For example, a stolen transaction card or smart device may be used as a payment mechanism to generate a payment request that is approved and initiated by the financial institution, resulting in execution of a fraudulent transaction. That is, in such situations, fraud prevention policies and procedures may be under-inclusive, failing to block fraudulent transactions, thereby harming the customer associated with the account that was fraudulently used and/or monetarily and/or reputationally harming the financial institution itself.

Aspects of the present disclosure advantageously provide for payment initiation that is automatically triggered by identity verification of the payor at the physical location where the payment request is made. For example, a customer can go a jog carrying just their driver's license, which they can also use to make a purchase for water or a sports drink, without having to carry an extra form of payment (e.g., a smartphone, a smartwatch, a credit card, cash, and the like).

Further aspects of the present disclosure advantageously provide for an enhanced or augmented unique identifier of a person.

Further aspects of the present disclosure advantageously provide for payment systems that include multiple devices, such as a unique identifier of the payor, a scanning device that scans the unique identifier, and a server, where the server, based on input from the scanning device, processes identification verification of a payor at a physical location where the payment request is made simultaneously with the payment request itself and/or other contextual information surrounding the payment request to determine whether to initiate the requested payment. In this aspect and other aspects, the devices perform transmission, receipt, and processing of particular signals between one another.

These and other examples herein are technological improvements specifically within the technological field of personal identity verification.

### System Overview

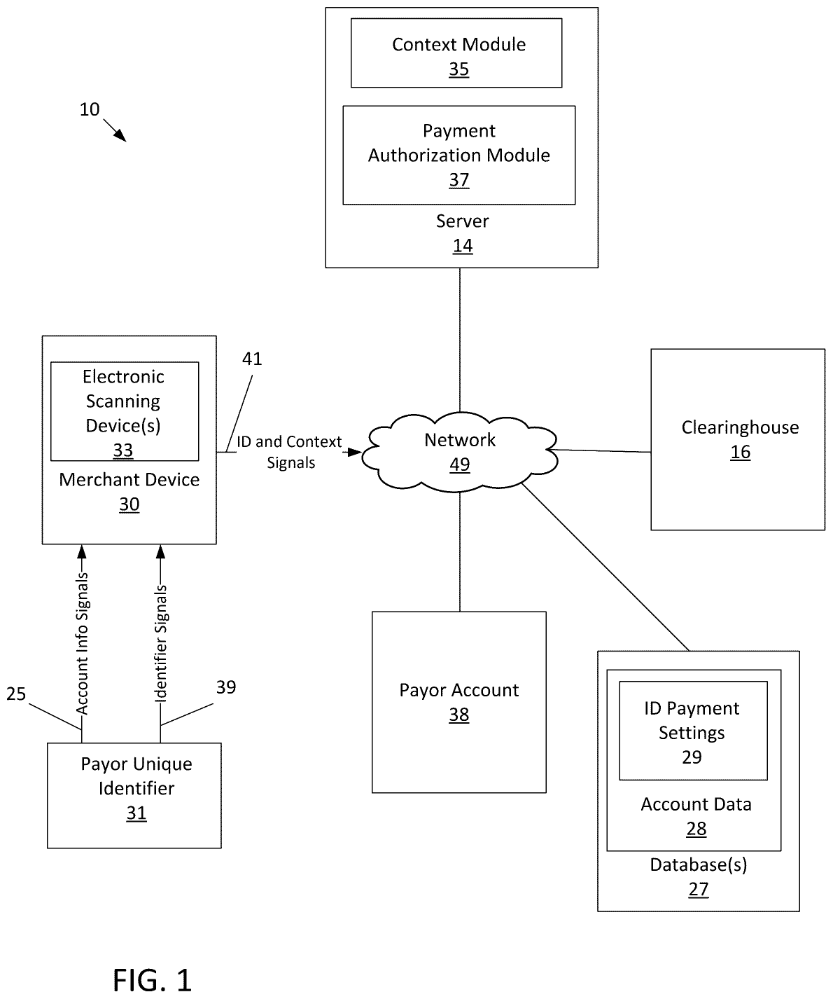

FIG. 1 shows an example identification-based payment management system 10.

The system 10 includes a server 14, a clearinghouse 16, a payor unique identifier 31, a merchant device 30, and a payor account 38 that are networked together via a network 49.

The server 14 can be managed by a financial institution. The server 14 can represent a single server, e.g., that is operated exclusively by a financial institution. Alternatively, the server 14 can include multiple computing devices, with the functionality of the server 14 being distributed across the multiple computing devices using the network 49. For instance, the server 14 can represent a computing cloud that a financial institution accesses to perform functions of the server 14 described herein.

The server 14, the clearinghouse 16, and the merchant device 30 each can include a processor and non-transitory computer readable storage storing instructions executable by the respective processor to perform functions described herein.

The payor account 38 is supported by one or more computing devices, such as the server 14.

The network 49 can be any suitable network or combination of networks for operably coupling computing devices to one another so that the computing devices can communicate computing signals between one another.

The merchant device 30 can include, for example, a smartphone, a tablet, a smartwatch or other smart wearable technology, a virtual reality device, an augmented reality device, a desktop computer, a transaction card reader, a point-of-sale terminal, and the like.

The server 14 stores, or has access via the network 49, to one or more databases 27, that store account data 28 for accounts held by customers of a financial institution. For example, such account data 28 can include account data about the payor account 38.

The account data 28 can include customer information associated with different transaction accounts of customers, such as an account number, a type of account (e.g., checking, savings, credit), the name of the account owner, whether the account is a business account or a personal account, customer contact information, customer age, customer work profile, customer address and contact information, information about customer communication data with a financial institution, and the like.

The account data 28 can also include identification (ID) payment settings 29 specific to each account of each customer.

The ID payment settings 29 include customer-specific rules and/or account-specific rules that define contexts in which verification of a customer's payor unique identifier 31 automatically permits initiation of a requested transaction by that payor. Such rules can be set by the financial institution, by the customer, or by both the financial institution and the customer.

For instance, one rule can be that verification of a customer payor unique identifier 31 automatically permits initiation of a requested transaction by that payor when the payor unique identifier is a passport and the transaction is prompted by a merchant device 30 that is located in particular a predefined country, or located at an airport.

Another rule can be that verification of a customer's payor unique identifier 31 automatically permits initiation of a requested transaction by that payor when the payor unique identifier is a driver's license and the transaction is prompted by a merchant device 30 that is located within a predefined zip code, or within a predefined distance from a home address of the payor.

Another rule can be that verification of a customer's payor unique identifier 31 automatically permits initiation of a requested transaction by that payor when the payor unique identifier is a passport and the transaction is one of a set of predefined types of transaction, such as a visa for crossing a national border or entering another country, duties associated with international travel, canceled flights, hospitalization, prolonged stays due to natural and human-caused disasters, and the like.

Another rule can permit initiation of a requested transaction by that payor when the payor unique identifier is a driver's license and the transaction is requested in a predefined range of time e.g., between 5 o'clock in the morning and midnight.

The factors that define permitted and prohibited contexts for requested payments can be configured to prohibit requested payments that have at least predefined minimum likelihood of being fraudulent, such as an attempted purchase with a driver's license at 3 o'clock in the morning, or an attempted purchase in Germany when the payor has set ID payment settings 29 to permit ID-based payments in the United Kingdom and Spain only because the payor is travelling to the United Kingdom and Spain only.

The customer can access their payor account 38 (e.g., by providing credentials to a web application or a personal application on their smart device) and provide or update their ID payment settings 29 via user interfaces as desired and to the extent permitted by the financial institution. That is, the ID payment settings 29 determine, for each account of each payor who holds a payor account 38 with the financial institution, the context or contexts in which automatic initiation of a requested transaction by the payor is permitted to occur simply by verification of a unique identifier (or specific type of unique identifier) of the payor, and the contexts in which transactions are prohibited.

As discussed above, any of a number of different factors can define a permitted context or a prohibited context. For example, each permitted context can be defined by one or more factors such as a type of requested payment, an amount of a requested payment, a type of the merchant, a location of the merchant (for example, the merchant device 30 can provide the server 14 with its location, e.g., based on internet protocol address), a type of the unique identifier, a time of day of the requested purchase, and the like.

In some examples, the contexts defined in the ID payment settings 29 can guarantee initiation of a payment or guarantee access to cash (e.g., in a foreign currency) up to a predefined amount and regardless of the liquidity or balance of the payor account 38 at the time the payment is requested. For example, a payor with a U.S. passport presents the passport at a border crossing between two countries where payment of $400 is required for a visa to cross the border. Even though the payor account has a balance of only $200, the ID payment settings 29 can permit the payment to go through, effectively automatically approving a loan in the amount of the difference between the payment being charged and the balance in the account. This is an example of situations in which certain types of transactions that may be critical to a customer's health and/or safety can be advantageously guaranteed (e.g., with preapproved loans) by the financial institution even if the payor's account does not have the requisite funds. In a similar example, the U.S. passport grants the customer access to a lockbox (e.g., at an airport, a border crossing, or an amusement park in a foreign country) containing sufficient cash in a required foreign currency to make the requested payment.

### Example Implementations

Example implementations of the components of the system of FIG. 1 will now be described.

Referring to FIG. 1, a payor is physically present at a merchant and presents a payor unique identifier 31 at a point of purchase. The payor unique identifier can be any such identifier described herein, such as a government issued passport, a government issued driver's license, or a biomarker.

In some examples, the merchant device 30 includes an electronic scanning device 33 configured to read the unique identifier 31. Depending on the form of the payor unique identifier 31 (e.g., in the case of a passport or a driver's license), the payor unique identifier may include a payment mechanism. Such a payment mechanism identifies the payor account 38 and can include, for example, a magnetic stripe printed on or embedded in a substrate of the unique identifier 31, a radio-frequency identification (RFID) tag, a near field communication (NFC) chip, or an integrated circuit (IC) chip. In these examples, the electronic scanning device 33 can include one or more of a magnetic stripe reader, a RFID tag reader, a NFC chip reader, or an IC chip reader.

In some examples, the merchant device 30 can include an additional electronic scanning device to scan and verify certain forms of the payor unique identifier 31, such as a biomarker. For example, when the unique identifier 31 is a biomarker, the merchant device 30 can include a scanning device 33 that includes a biomarker reader such as one or more of a retinal scanner, a fingerprint scanner or any other biomarker reader that can uniquely identify the payor. In these examples, the unique identifier 31 is, or at least includes, some kind of biomarker.

Thus, depending on the situation, the payor unique identifier, when scanned by one or more scanning devices 33, can generate identifier signals 39 and identify the payor who is physically present, and/or account information signals 25 that provide information about the payor account 38. The signals 25 and 39, generated by scanning the unique identifier 31 with the scanning device(s) 33 are provided to the merchant device 30.

If the payor's identity is verified (either directly by the merchant device 30 using an electronic scanning device 33, or by the merchant viewing the payor unique identifier and, in some examples, confirming via an input device of the merchant device 30 that the payor's identify has been verified), ID and context signals 41 are generated by the merchant device 30 and provided, via the network 49, to the server 14.

The ID and context signals 41 provide the server 14 with data indicating that an ID-based payment has been requested, that the requested payment is associated with the payor account 38, and that the physical presence of the payor at the point of purchase has been verified together with the payor unique identifier and context factors relating to the requested payment. The context factors can include any of the factors described above, such as a location of the merchant device 30, a time of day that the payment was requested, the type of purchase being requested, the type of payor unique identifier 31 that was used for verification, and the like.

Using the context module 35, the server 14 processes the ID and context signals 41 and determines if the context of the requested payment is a permitted ID-based payment or a prohibited ID-based payment by accessing the ID payment settings 29 and comparing the context factors provided in the context signals 41 with the ID payment settings 29 associated with the payor account 38. If the provided context matches a set of context factors stored in the ID payment settings 29 for a permitted context, then the context module 35 determines that the requested payment is permitted. If the provided context matches a set of context factors stored in the ID payment settings 29 for a prohibited context, or simply does not match any set of context factors stored in the ID payment settings 29 for a permitted context, then the context module determines that the requested payment is prohibited.

If the server 14 determines that the requested payment is prohibited, the payment authorization module 37 is configured to generate an output that the requested payment is denied. For example, the server 14 generates signals that are provided to the merchant device 30 carrying a message that is provided via an output device of the merchant device 30 that the requested transaction has been denied.

If the server 14 determines that the requested payment is permitted, the payment authorization module 37 causes the server 14 to generate a digital key. The digital key can be encrypted by the server 14 or by a third party encryptor linked to the network 49. The digital key is provided to the clearinghouse 16 and gives the clearinghouse 16 access to the payor account 38 to perform the payment at the requested payment amount and to the requested payee account. The clearinghouse 16 then performs the payment, withdrawing the payment amount from the payor account 38 and depositing it in the requested payee account (e.g., an account of the merchant).

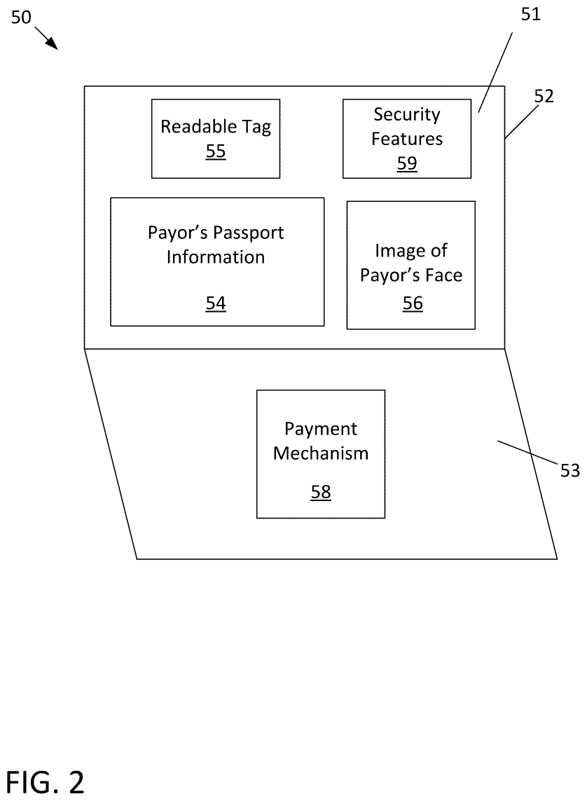

FIG. 2 shows an example augmented passport 50, which is another example implementation of an aspect of the system 10 of FIG. 1. Specifically, the augmented passport 50 is an example of the payor unique identifier 31 of FIG. 1.

The passport 50 includes a substrate 52 (e.g., a plastic card or laminated paper). In some examples, the substrate 52 can take the form of a book or a booklet with multiple bound pages. In this example, two pages 51 and 53 of the substrate 52 are shown. In some examples, the components of the two pages 52 and 53 can be combined on a single page, or on more than two pages.

The page 52 includes the payor's passport information 54 and an image of the payor's face 56 (e.g., a photograph or printed image of the payor's face). The passport information 54 can include, for example, information printed on, embedded in, or otherwise encoded in the substrate 52 that identifies the name of the payor, nationality, place of birth, passport date of issue, passport date of expiration, and a unique government-issued passport number. The passport information 54 and the image 56 can be sufficient to enable the payor associated with the passport to lawfully enter a plurality of countries.

The pages of the passport can also include one or more security features 59 (e.g., a watermark, a hologram, traceable ink with a particularly selected chemical footprint, and so forth) so that it can be easily verified that the passport is legitimate and not counterfeit.

The substrate 52 also includes printed thereon, embedded or otherwise encoded therein, a payment mechanism 58. The payment mechanism 58 encodes and thereby identifies a transaction account of the payor. The payment mechanism 58 can include, for example, one or more of a magnetic stripe, a RFID tag, a NFC chip, and an IC chip. The payment mechanism 58 is configured to be scanned by an appropriate scanning device (such as those described herein) to request a payment for a proposed transaction from the payor's transaction account identified by the payment mechanism 58 and thereby initiate, if approved, the payment directly from the passport 50.

The passport 50 can also include a readable tag 55. The readable tag 55 can include, for example, one or more of a magnetic stripe, a RFID tag, a NFC chip, and an IC chip and can be read by an appropriate scanning device. The readable tag 55 can encode some or all of the payor's passport information 54 that can then be provided to a computing device (e.g., the merchant device 30 of FIG. 1) via the appropriate scanner.

In some examples, a single mechanism (e.g., a magnetic stripe, a RFID tag, a NFC chip, or an IC chip) can be printed on or otherwise embedded in the substrate 52 and provide both some or all of the payor's passport information 54 and also serve as the payment mechanism by encoding information about the payor's transaction account 38 (FIG. 1).

The features and functionality of the passport 50 can be applied to other substrate-based or document-based unique identifiers, such as a government issued driver's license.

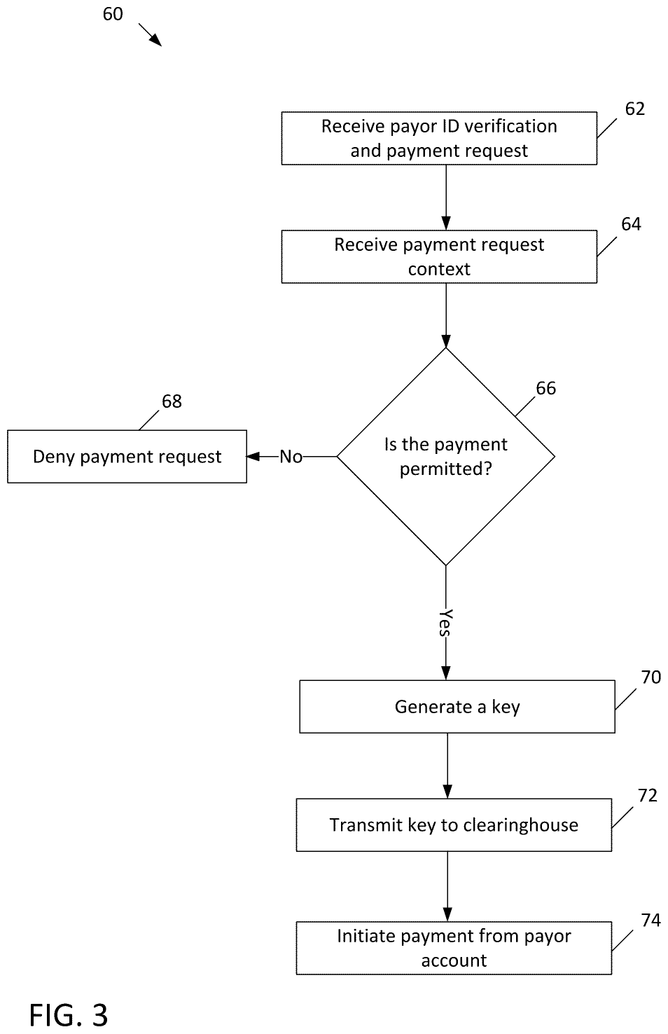

FIG. 3 shows an example method 60 that can be performed by the payment managing system 10 of FIG. 1. The steps of the method 60 can be performed, e.g., by the various modules of the server 14 as described in connection with FIG. 1 and/or other devices of the system 10. Additional methods may include some but not all of the steps of the method 60. Additional methods may include some or all of the steps of the method 60 performed in a different order than that illustrated.

Referring to FIG. 3, prior to the step 62, if an ID-based payment request resulted in an unverified payor identification, then the method 60 does not begin and the requested payment is denied.

If the payor identification is verified for the ID-based payment, at a step 62 of the method 60, the payor's ID verification and payment request, e.g., from a merchant device, is received at the server 14 (FIG. 1).

At a step 64, which can occur simultaneously with the step 62 in some examples, the server 14 receives context data relating to the requested payment.

At a step 66, the server 14 determines, based on the context data received, whether the context is a permitted context or a prohibited context.

If the context is a prohibited context, then the method 60 proceeds to a step 68 and the requested payment is denied, effectively terminating the method.

If the context is a permitted context, then the method 60 proceeds to the step 70, at which the server 14 generates a digital key.

At a step 72 of the method 60, the key is transmitted to a clearinghouse or other payment system.

At a step 74, the clearinghouse or other payment system uses the key to access the verified payor's account and thereby initiates the requested payment from the payor's account to the requested payee's account (e.g., the merchant's account) for the requested transaction amount.

In another example implementation of the system of FIG. 1, the unique identifier can be a software tool or plug-in that can be embedded within a transaction account management software application or web-based application that links the transaction account to a passport of the user. Such tool can automatically identify requested payments that have permitted contexts (e.g., at border crossings or for visas) and that require a passport.

For example, a customer can upload her passport to a mobile banking application on her computing device. The banking application verifies the information on the passport (e.g., name, address, etc.). When the customer enters a country, any fees associated with entry (e.g., entrance fees, duty fees, etc.) are automatically charged to a transaction account, such as a checking account, a credit card account or a mobile or digital wallet, associated with the same banking application that has verified the identity of the physically present payor via the uploaded passport information.

In this example, the payor's transaction account software application ties a verified passport to context-permitted online transactions that require proof of payor identification. The payor's passport is thereby connected to a financial transaction account for those permitted fees.

### Example Computing Environment

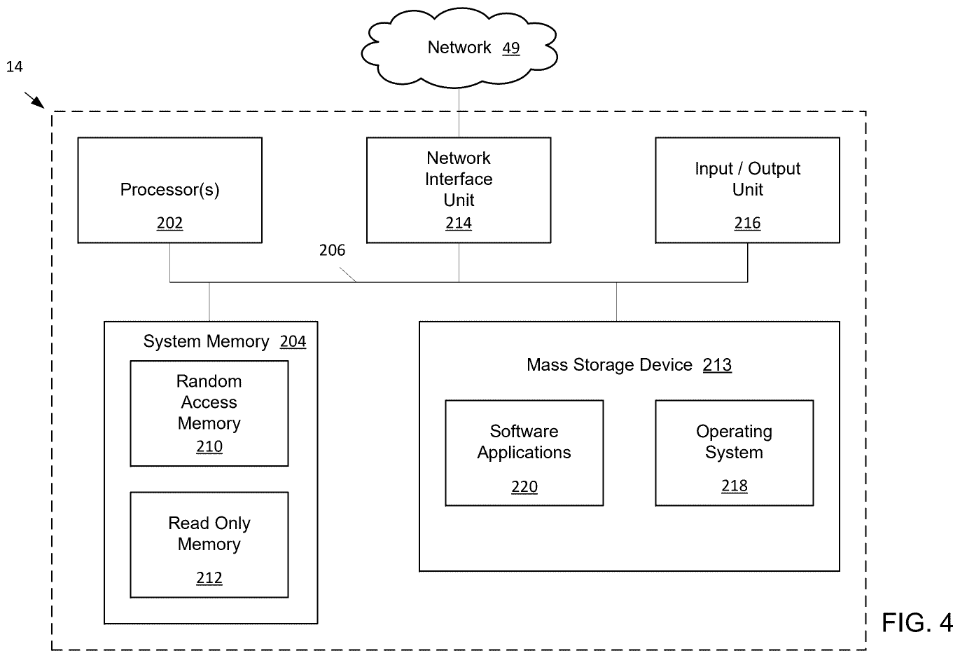

Additional components of the server 14 are illustrated in FIG. 4.

In this example of FIG. 4, the server 14 provides the computing resources to perform at least some of the functionality associated with the system 10 (FIG. 1).

The server 14 can be an internally controlled and managed device (or multiple devices) of an enterprise, e.g., a financial institution that offers various banking services to its customers. Alternatively, the server 14 can represent one or more devices operating in a shared computing system external to the enterprise, such as a cloud. Further, the other computing devices disclosed herein, such as the merchant device 30, the clearinghouse 16, and any computing device that serves the payor account 38 (FIG. 1) can include the same or similar components.

Via the network 49, any components of the server 14 that are physically remote from one another can interact with one another, as well as with other computing resources, such as those shown in FIG. 1. The network 49 can be any suitable wired, wireless, cellular or other data network (or combination of networks) that enables data transmission between computing devices networked together.

The server 14 includes one or more processors 202. The one or more processors 202 are configured to carry out the functionality of the system 10 described above by executing computer-readable instructions stored on non-transitory computer-readable storage. The server 14 also includes a system memory 204 and a system bus 206 that couples the system memory 204 to the processor(s) 202.

The system memory 204 includes a random access memory (“RAM”) 210 and a read-only memory (“ROM”) 212. A basic input/output system that contains the basic routines that help to transfer information between elements within the server 14, such as during startup, is stored in the ROM 212.

The server 14 further includes a mass storage device 213. The mass storage device 213 is able to store software instructions and data such as those required for the context module 35 and the payment authorization module 37 (FIG. 1), as well as to carry out any further functions of the server 14.

The mass storage device 213 is connected to the processor(s) 202 through a mass storage controller (not shown) connected to the system bus 206. The mass storage device 213 and its associated computer-readable data storage media provide non-volatile, non-transitory storage for the server 14. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server 14.

According to various embodiments of the invention, the server 14 may operate in a networked environment using logical connections to remote network devices (such as the merchant device 30, the clearinghouse 16, and other computing devices supporting the payor account 38 shown in FIG. 1) through the network 49, such as a wireless network, the internet, or another type of network. The server 14 may connect to the network 49 through a network interface unit 214 connected to the system bus 206. It should be appreciated that the network interface unit 214 may also be utilized to connect to other types of networks and remote computing systems. The server 14 also includes an input/output unit 216 for receiving and processing input from a number of other devices, including a touch user interface display screen, an audio input device, or another type of input device.

As mentioned briefly above, the mass storage device 213 and/or the RAM 210 of the server 14 can store software instructions and data. The software instructions include an operating system 218 suitable for controlling the operation of the server 14. The mass storage device 213 and/or the RAM 210 also store software instructions and applications 220, that when executed by the processor(s) 202, cause the server 14 to provide functionality of the system 10 described above (FIG. 1).

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. An augmented passport, comprising:
a substrate;
information printed on or otherwise encoded on the substrate sufficient to enable a payor to lawfully enter a plurality of countries; and
a payment device printed on or embedded within the substrate, the payment device being configured to be scanned by an electronic scanning device to initiate a payment from an account associated with the payor.

2. The augmented passport of claim 1, further comprising an image of a face of the payor printed on or secured to the substrate.

3. The augmented passport of claim 1, wherein the payment device includes a magnetic stripe.

4. The augmented passport of claim 1, wherein the payment device includes a radio-frequency identification (RFID) tag.

5. The augmented passport of claim 1, wherein the payment device includes a near field communication (NFC) chip.

6. The augmented passport of claim 1, wherein the payment device includes an integrated circuit (IC) chip.

7. A payment system, comprising:
an electronic scanning device;
at least one processor; and
memory encoding instructions which, when executed by the at least one processor, cause the at least one processor to verify an identification of a payor based on a scan, by the electronic scanning device, of a unique identifier to provide a verified identification, wherein the verified identification causes a payment to be initiated from an account associated with the payor.

8. The payment system of claim 7, wherein the electronic scanning device includes a magnetic stripe reader.

9. The payment system of claim 7, wherein the electronic scanning device includes a radio-frequency identification (RFID) tag reader.

10. The payment system of claim 7, wherein the electronic scanning device includes a near field communication (NFC) chip reader.

11. The payment system of claim 7, wherein the electronic scanning device includes an integrated circuit (IC) chip reader.

12. The payment system of claim 7, wherein the electronic scanning device includes a biometric reader.

13. The payment system of claim 12, wherein the unique identifier includes a biometric marker of the payor.

14. The payment system of claim 7,
wherein the memory encodes further instructions which, when executed by the at least one processor, cause the at least one processor to:
determine a context of the payment; and
determine, based on the context of the payment, whether the verified identification permits the payment,
wherein the verified identification causes the payment to be initiated from the account associated with the payor when the context permits the payment; and
wherein the verified identification does not cause the payment to be initiated from the account associated with the payor when the context does not permit the payment.

15. The payment system of claim 14, wherein the context includes one or more of:
a type of purchase to be made via the payment;
a geographic location of the electronic scanning device;
a geographic location of the unique identifier; and
an identifier of the electronic scanning device.

16. A method of executing a payment, comprising:
receiving, by a server, a verification of a unique identifier of a payor and a request to initiate the payment;
generating, by the server, a key based on the verification; and
electronically initiating the payment by providing the key to a clearinghouse, the key being configured to enable the clearinghouse to withdraw the payment from an account of the payor.

17. The method of claim 16, wherein the unique identifier is provided on a document.

18. The method of claim 16, wherein the unique identifier includes a biometric marker.

19. The method of claim 16, further comprising:
receiving, by the server, a context of the payment;
generating the key by the server when the context permits the payment; and
not generating the key by the server when the context does not permit the payment.

20. The method of claim 19, wherein the context includes one or more of:
a type of purchase to be made via the payment; and
a geographic location of the unique identifier.
